(19) United States
(12) Patent Application Publication
(10) Pub. No.: US 2006/0143282 A1
(43) Pub. Date: Jun. 29, 2006

(54) Tailoring content for mobile electronic device based on network

(76) Inventors: Michael K. Brown, Kitchener (CA); Thomas C. Nagy, Waterloo (CA)

Correspondence Address: RIDOUT & MAYBEE;SUITE 2400, ONE QUEEN STREET EAST, TORONTO, ON, M5C3B1, CA

(21) Appl. No.: 11/020,151

(22) Filed: Dec. 27, 2004

(51) Int. Cl. G06F 15/16

(52) U.S. Cl. 709/217; 709/219; 709/227

(57) ABSTRACT

A system and method for adapting data for transmission to a mobile electronic device (10) in a communications system (100) that includes at least a first wireless network (110) and a second wireless network (130) having respective coverage areas wherein the mobile electronic device (10) receives data signals from a data conversion device (116) through one of the wireless networks (110, 130) based on a location of the mobile electronic device (10). Content that is destined for the mobile electronic device (10) through a selected one of the wireless networks is received at the data conversion device (116). The content is adapted at the data conversion device based on the selected wireless network (110, 130) and outputted for transmission over the selected wireless network (110, 130) to the mobile electronic device (10).

### FIELD OF TECHNOLOGY

The present application relates to preparing content for delivery to mobile electronic devices.

### BACKGROUND INFORMATION

The downloading experience between a wireless enabled mobile electronic device and a content source greatly depends on the communications channel between the mobile electronic device and the content source. For example, wireless devices used within a packet based cellular wireless wide area network, such as a GPRS network for example, typically have a relatively limited bandwidth available to them such that downloading rich content may be a slow, frustrating and expensive experience. Conversely, a wireless device used within a Wi-Fi network, for example an 802.11 network, will typically have much greater bandwidth available to it such that downloading rich content is relatively fast.

Thus, downloading of the same content is not an identical experience over different networks. There is need for a system and method for addressing the differences in receiving content over different networks.

### BRIEF SUMMARY

According to example aspects of the invention, downloadable content such as Internet web pages and email messages are tailored prior to transmission to the mobile electronic device based on the wireless network that the content is being sent over.

In one aspect, the present application provides an automated method for adapting data for transmission to a mobile electronic device (10) in a communications system (100) that includes at least a first wireless network (110) and a second wireless network (130) having respective coverage areas wherein the mobile electronic device (1 0) receives data signals from a data conversion device (116) through one of the wireless networks (110, 130) based on a location of the mobile electronic device (10). The method includes receiving at the data conversion device (116) content that is destined for the mobile electronic device (10) through a selected one of the wireless networks, and adapting at the data conversion device the content based on the selected wireless network (110, 130) and outputting the adapted content for transmission over the selected wireless network (1 10, 130) to the mobile electronic device (10).

In another aspect, the present application provides a wireless connector system (114) for interfacing between a content source and at least a first wireless network (110) and a second wireless network (130), the wireless networks (110, 130) having respective coverage areas for providing service to a plurality of mobile electronic devices. The wireless connector system (114) includes data conversion means for (i) receiving from the content source content that is destined for a mobile electronic device (10) through a selected one of the wireless networks (110, 130) and (ii) adapting the content based on the selected wireless network (110, 130) and outputting the adapted content. The wireless connector system is configured to provide the content outputted by the data conversion means to the selected wireless network for sending to the mobile electronic device.

### BRIEF DESCRIPTION OF THE DRAWINGS

Embodiments will now be described, by way of example only, with reference to the attached Figures, wherein:

FIG. 1 is a block diagram of a communications system to which embodiments may be applied;

FIG. 2 is a block diagram of a method for processing a web page according to example embodiments of the invention;

FIG. 3 is a block diagram of a method for processing an email message according to example embodiments of the invention; and

FIG. 4 is a block diagram showing an example of a mobile electronic device that can be used in the communications system of FIG. 1.

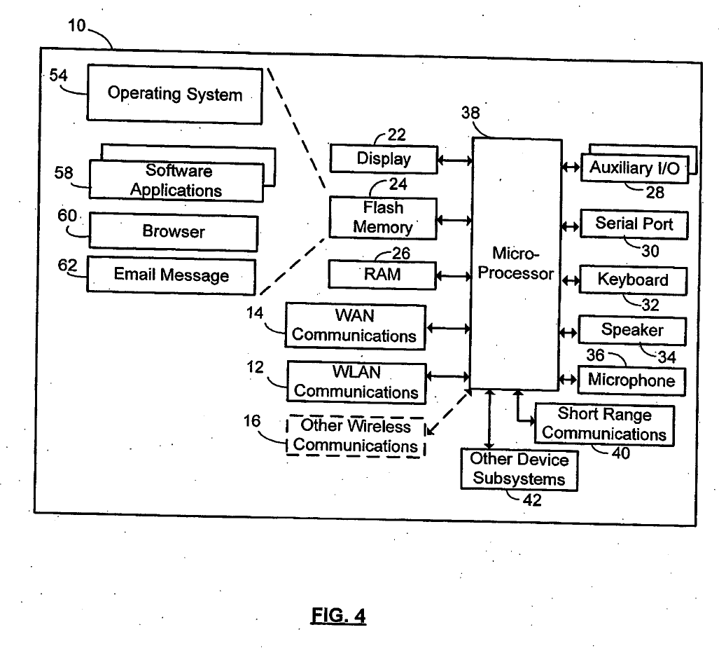

Like reference numerals are used throughout the Figures to denote similar elements and features.

### DETAILED DESCRIPTION

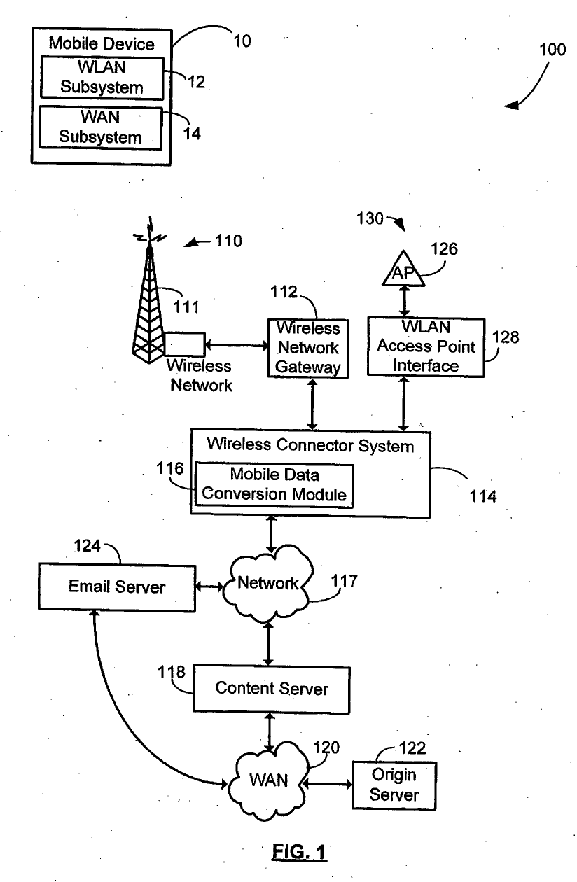

Referring first to FIG. 1, there is a block diagram of a communication system 100 according to at least one example embodiment of the present invention. The communication system 100 includes mobile electronic devices 10 (only one of which is shown in FIG. 1), a wireless wide area network (WAN) 110 and a wireless local area network (WLAN) 112.

Wireless WAN 110 in at least some example embodiments is a packet based cellular network that includes a plurality of base stations 111 (one of which is shown In FIG. 1) that each provide wireless RF coverage to a corresponding area or cell. Wireless WAN 110 will typically be operated by a cellular network service provider that sells subscription packages to users of mobile electronic devices. Wireless WAN 110 could be a number of different types of network including by way of non-limiting example, Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network) or various other third generation networks such as EDGE (Enhanced Data rates for GSM Evolution) or UMTS (Universal Mobile Telecommunications Systems).

The communications system 100 also includes a wireless network gateway 112 and a wireless connector system 114. The wireless network gateway 112 provides translation and routing services between one or more wireless connector systems 114 and WANs 110 to facilitate communication between mobile electronic devices 10 and devices connected, directly or indirectly, to wireless connector system 114.

WLAN 130 in at least some example embodiments conforms to IEEE 802.11 standards, for example 802.11b and/or 802.11g, however other communications protocols could also be used for WLAN 130. As known in the art, WLAN 130 includes a plurality of wireless radio frequency (RF) access points (AP) 126 (one of which is shown in FIG. 1) that collectively provide a WLAN coverage area. In an example embodiment, WLAN 130 is operated by an enterprise (such as a business or university for example) and access points 126 are connected to an access point (AP) interface 128. The AP interface 128 provides translation and routing services between access points 126 of WLAN 130 and wireless connector system 114 to facilitate communication between mobile electronic devices 10 and devices connected, directly or indirectly, to wireless connector system 114. The AP interface 128 may be implemented by a computer such as a server running a suitable software program.

The wireless connector system 114 is a server that in at least some examples is located behind a firewall and provides access for mobile electronic devices 10, through either wireless WAN 110 or WLAN 130, to the devices connected, for example through an enterprise network such as an intranet 117, to the wireless connecter system 114. The wireless connector system 114 includes a mobile data conversion module 116 that adapts content and information received from devices connected to wireless connector system 114 for transmission over wireless WAN 110 or WLAN 130 to mobile electronic devices 10. As will be explained In greater detail below, the mobile data conversion module 116 selectively adapts the content being sent to the mobile electronic device 10 based on whether the content is being sent over wireless WAN 1 10 or WLAN 130. In at least one embodiment, the data conversion module 116 is implemented through computer program instructions that reside on a persistent storage on the wireless connector system 114, and which are executed by one or more microprocessors. In some embodiments, the data conversion module 116 could be implemented on a separate computer than the other components of wireless connector system 114.

The enterprise network 117 may include a local area network, an intranet, the Internet, a direct connection, and combinations thereof, however in at least some example embodiments enterprise network 117 will be an intranet for a corporation or organization. An application/content server 118 may be connected to the client network 117 and also to a further network such as a Wide Area Network (WAN) 120. The WAN 120 may connect with other networks, and the WAN 120 can in various embodiments include the Internet, a direct connection, a local area network (LAN), a wireless communication link, and any combinations thereof. Content providers, such as web servers, may be connected to the WAN 120, an example of which is shown in FIG. 1 as origin server 122. An email server 124 is in at least one configuration connected to the enterprise network 117. The email server 124 is configured to direct or redirect email messages received over WAN 120 and internally within enterprise network 117 to addressed mobile electronic devices 10.

In an example embodiment, the data conversion module 116 provides HTTP connectivity between the wireless WAN 110 and WLAN 130 and devices and/or networks connected directly or indirectly to wireless connector system 114. The network 117, application/content server 118, WAN 120 and origin server 122 are collectively and/or individually or in various combinations a content source for the wireless connector system 114. The system shown in FIG. 1 is but one possible configuration for a communications system on which embodiments of the invention may be implemented.

In one example embodiment, mobile electronic devices 10 are hand-held two-way mobile communication devices 10 having at least data and possibly also voice communication capabilities. In an example embodiment, the devices 10 have the capability to communicate with other computer systems on the Internet. In various embodiments, mobile electronic devices 10 may include, by way of non limiting example, data communication devices, multiple-mode communication devices configured for both data and voice communication, mobile telephones, mobile communication devices, PDAs enabled for wireless communications, and wireless modems operating in conjunction with computer systems.

In the presently described embodiment, mobile electronic device 10 is configured to operate within the wireless WAN 110 and the WLAN 130 and in this regard includes a WAN communications subsystem 14 for communicating with wireless WAN 110 and a WLAN communications subsystem 12 for communicating with access points 126 of WLAN 130. Wireless WAN 110 and WLAN 130 have coverage areas that at least partially overlap. In at least some example embodiments, the coverage area of wireless WAN 110 is much larger than that of WLAN 130 and may overlap all or a large percentage of the coverage area of WLAN 130. However, WLAN 130 may have sole coverage in some regions that are dead spots in wireless WAN 110, for example, some Interior locations of an enterprise's buildings. Typically, the channel resources such as bandwidth available for providing content to a mobile electronic device 10 will be greater through WLAN 130 than through wireless WAN 110.

In example embodiments the mobile electronic device 10 is configured to communicate over WLAN 130 when within the coverage area of WLAN 130, and over wireless WAN 110 when outside of the coverage area of WLAN 130 and inside the coverage area of wireless WAN 110. Such a configuration, among other things, allows the mobile electronic device 10 to take advantage of the larger bandwidth available through WLAN 130 than wireless WAN 110.

According to example embodiments of the invention, content received by the data conversion module 116 that is destined for a mobile electronic device is adapted based on the wireless network that content is being sent over to the mobile electronic device 10.

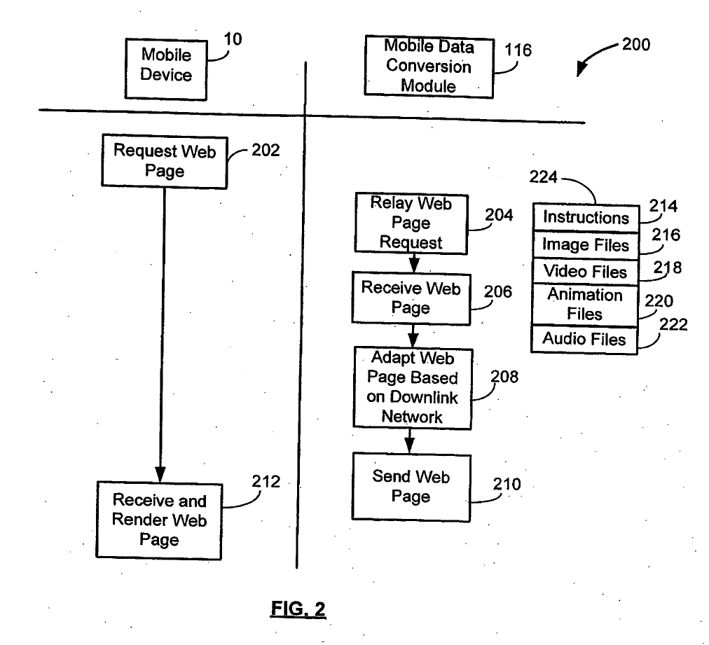

FIG. 2 provides a block diagram overview showing method 200 for processing a Web page according to example embodiments of the invention. In the method 200, as indicated in step 202, a mobile electronic device 10 having a Web browser transmits a web page request over the wireless network that it is currently using to communicate with wireless connector system 114, namely either wireless WAN 110 or WLAN 130. As known in the art, the information needed for rendering a Web page 224 will typically include an instruction file 214 and possibly associated Image files 216, video files 218, animation files 220 and/or audio files 222. The instruction file may be an HTML file which defines the structure and layout of a Web document by using a variety of tags and attributes, which in turn refer to image files 216, video files 218, animation files 220 and audio files 222. Image files could include for example, PNG graphics files or different graphic file formats such as JPEG or GIF for example. Video and/or animation files could include flash or MPEG files, among other formats, and audio files could include MP3 files, among other formats.

Turning again to FIG. 2, the web page request from mobile electronic device 10 is routed through either wireless WAN 110 or WLAN 130 to the data conversion module 116 of wireless connector system 114. As indicated in step 204, the data conversion module 116 relays the web page request to the source of the web page. In one example, the web page request may be routed through client network 117, application/content server 118, and Internet 120 to an origin server 122 on which the requested web page resides. In some examples, the application/content server 118 or another server connected to the data conversion module 116 through client network 117 could be the origin server. As indicated instep 206, the data conversion module 116 receives the requested web page, including the HTML file 124 and any referenced image, video, animation and/or audio files.

As indicated in step 208, once the data conversion module 116 receives the requested web page it adapts the web page based on the network (wireless WAN 110 or WLAN 130) that will be used as the downlink channel when the web page is sent over to the requesting mobile electronic device 10. In one example embodiment, the mobile electronic device 10 is configured to advise the data conversion module 116 when, or prior to, making the web page request what network will be used as the downlink network. The mobile electronic device 10 can derive this information based on the current network that it is using for wireless communications. In other embodiments, the wireless connector system 114 tracks what network is being currently used for wireless communications with the mobile electronic device 10, and passes that information onto the data conversion module 116 either with the web page request when it is received from the mobile electronic device 10, or in reply to an inquiry from the data conversion module 116.

When adapting the web page, the data conversion module adapts the web page to accommodate for the resources, for example channel bandwidth, available on the network 110 or 130 that is to be used for the downlink. For example, in one embodiment, if the downlink network is the higher speed WLAN 130, the web page content 224 is generally unaltered by the data conversion module 116 and is left substantially or completely as received from the content source. Thus, in some embodiments, there will be situations where the data conversion module 116 determines, based on the downlink network, that the web page does not need to be adapted and sends the unadapted web page out.

However, if the downlink network is the slower speed wireless WAN 110, then the size of the web page content 224 is pared down to speed up its transmission time. For example, in one embodiment, the data conversion module 116 removes selected files from the web page content 224. For example, in one configuration, all video, animation and audio files 218, 220 and 222 are removed from web page content 224. In other configurations, video animation and/or audio files 218, 220 and 222 above predetermined file sizes are deleted. The threshold sizes may be set according to file type. In some configurations, image files 216 are also deleted, and in some configurations, image files 216 above a certain threshold size are deleted. In some example embodiments, image files 216 are converted to lower resolution images in order to reduce file size.

In one example, the instruction file (e.g. HTML (Hypertext Markup Language) source code) 214 is amended by data conversion module 116 to remove references to the deleted content. In another alternative configuration, the browser on the device 10 is configured (for example, through a plug in) to ignore references to certain file types in the instruction file 214 when a web page is loaded over the slower wireless WAN 110, in order to take into account that such files have been removed back at the data conversion module 116.

As indicated above, in some embodiments, the mobile data conversion module 116 leaves web page content that is going to be sent over WLAN 130 unamended. In some other example embodiments, a more limited set of changes may be done for web pages that are transmitted over WLAN 130 than wireless WAN 110. For example, the threshold sizes for deleting video, animation and/or audio files may be higher for WLAN 130 than wireless WAN 110.

Referring again to FIG. 2, as indicated in step 210, once the requested web page has been processed by the data conversion module 116 the processed web page is then sent over the appropriate wireless network 110 or 130 to the requesting mobile electronic device 10. As indicated in step 212, device 10 then renders the received web page on its display screen.

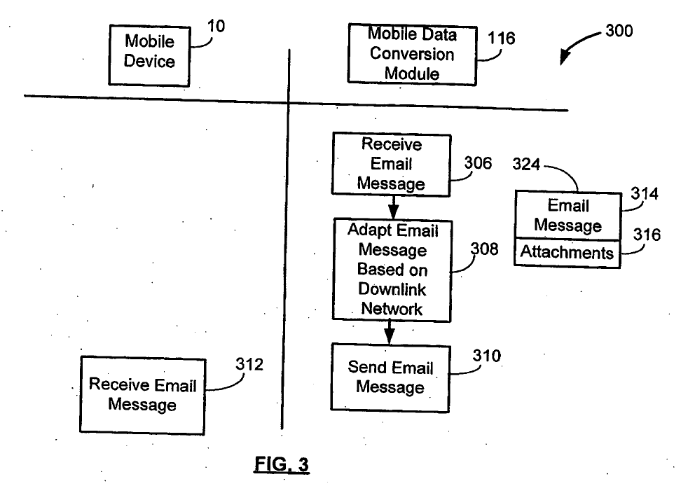

The network-based content adapting methods described herein can also be applied to other content downloaded to a device 10, including for example email messages. FIG. 3 shows a method 300 used by data conversion module 116 when adapting an email message. Method 300 is similar to method 200 described above, with differences that will be apparent based on the following description. As indicated in step 306, the data conversion module 116 receives an email message destined for a specific mobile electronic device 10. In some embodiments, email messages are automatically pushed out from email server 124 to mobile electronic device 10. In other embodiments, email messages are sent to mobile electronic device 10 after a request is received from the device 10. As known in the art, an email message 324 will often include a text message 314 packaged using a format such as HTML, which may include special font information for the text message. The message may also include one or more attached files 316.

When adapting the email message 324, the data conversion module adapts the email message to accommodate for the resources, for example channel bandwidth, available on the network 110 or 130 that is to be used for the downlink.

For example, if the downlink network is the slower speed wireless WAN 110, then the size of the email message 324 is pared down to speed up its transmission time. For example, in one embodiment, the attachments 316 are stripped out of the email message. In some embodiments, attachments 316 above a threshold size are striped out, while smaller attachments are kept. In some embodiments, attachments 316 of certain file types are kept while attachments of other file types are stripped out. In some embodiments, formatting information (for example HTML code) and/or font information is stripped out of the text portion 314 of the email message to convert it to a plain text message and reduce its size.

In some embodiments, when the downlink network is the higher speed WLAN 103, the mobile data conversion module 116 leaves the email message text portion 314 unchanged, keeping the formatting and font information. In some embodiments, attachments may be kept in messages sent over WLAN 130. In some other example embodiments, a more limited set of changes may be done for email messages that are transmitted over WLAN 130 than wireless WAN 110. For example, the threshold sizes for deleting attachment files may be higher for WLAN 130 than wireless WAN 110.

Referring again to FIG. 3, as indicated in step 310, once the email message has been processed by the data conversion module 116 it is then sent over the appropriate wireless network 110 or 130 to the receiving mobile electronic device 10. As indicated in step 312, device 10 receives the email message where it is saved for viewing through email message viewing software resident on the device 10.

An example of a mobile electronic device 10 with which at least some embodiments of the invention may be used is shown in FIG. 14. The device 10 includes wireless WAN communication subsystem 14 for two-way communications with wireless WAN 110, and WLAN communications subsystem 12 for two-way communications with WLAN 130. Communications subsystems 12, 14 in one example each include respective antennas, RF transceivers, and some signal processing capability, implemented for example by a digital signal processor. The device 10 includes a microprocessor 38 that controls the overall operation of the device. The microprocessor 38 interacts with communications subsystems 12 and 14 and also interacts with further device subsystems such as the display 22, flash memory 24, random access memory (RAM) 26, auxiliary input/output (I/O) subsystems 28 (which may include a thumb-wheel, for example), serial port 30 (which may include a USB port, for example), keyboard or keypad 32, speaker 34, microphone 36, a short-range communications subsystem 40, and any other device subsystems generally designated as 42.

Operating system software 54 and various software applications 58 used by the microprocessor 38 are, in one example embodiment, stored in a persistent store such as flash memory 24 or similar storage element. Software applications 58 may include a wide range of applications, including an address book application, a messaging application, a calendar application, and/or a notepad application. One application included among applications 58 in web-enabled embodiments of device 10 is a web browser 60. Another application is an email message viewer 62. Each software application, 58 may include layout information defining the placement of particular fields in the user interface for the software application 58, such as text fields, input fields, etc. Those skilled in the art will appreciate that the operating system 54, specific device applications 58, or parts thereof, may be temporarily loaded into a volatile store such as RAM 26. Received communication signals may also be stored to RAM 26.

The microprocessor 38, in addition to Its operating system functions, enables execution of software applications 58 (which can include software applications 60 and 62) on the device. A predetermined set of applications 58 which control basic device operations, including at least data and voice communication applications for example, will normally be installed on the device 10 during manufacture. Further applications may also be loaded onto the device 10 through the networks 110 or 130, an auxiliary I/O subsystem 28, serial port 30, short-range communications subsystem 40 or any other suitable subsystem 42, and installed by a user in the RAM 26 or a non-volatile store for execution by the microprocessor 38.

In a data communication mode, a received signal such as an email message or web page download will be processed by the WLAN communication subsystem 12 or the WAN communication subsystem 14 and input to the microprocessor 38, which will preferably further process the received signal for output to the display 22, or alternatively to an auxiliary I/O device 28. A user of device 10 may also compose data items such as email messages for example, using the keyboard 32 in conjunction with the display 22 and possibly an auxiliary I/O device 28. Such composed items may then be transmitted over a communication network through the communication subsystems 110 or 130.

The serial port 30 could be a USB type port implemented in a personal digital assistant (PDA)-type communication device for which synchronization with a users desktop computer (not shown) may be desirable. Such a port 30 would enable a user to set preferences through an external device or software application and would extend the capabilities of the device by providing for information or software downloads, including user interface information, to the device 10 other than through a wireless communication network.

A short-range communications subsystem 40 is a further component which may provide for communication between the device 10 and different systems or devices, which need not necessarily be similar devices. For example, the subsystem 40 may include an infrared device and associated circuits and components.

The process and systems disclosed above could also be used with wireless networks other than WLAN and wireless WAN cellular networks. For example, downlink to the device 10 may in some embodiments be carried out through wireless connector system and through a further wireless network such as an orthogonal frequency division multiplex (OFDM) network or a satellite network, and the device 10 may include a further communications subsystem 16 for receiving signals over such network(s), Based on the downlink network capability, downloaded content such as email messages and web pages are adapted In the manner discussed above.

The above-described embodiments of the present application are intended to be examples only. Alterations, modifications and variations may be effected to the particular embodiments by those skilled in the art without departing from the scope of the application, which is defined by the claims appended hereto.

What is claimed is:

1. An automated method for adapting data for transmission to a mobile electronic device in a communications system that includes at least a first wireless network and a second wireless network having respective coverage areas wherein the mobile electronic device receives data signals from a data conversion device through one of the wireless networks based on a location of the mobile electronic device, the method including:
receiving at the data conversion device content that is destined for the mobile electronic device through a selected one of the wireless networks;
adapting at the data conversion device the content based on the selected wireless network and outputting the adapted content for transmission over the selected wireless network to the mobile electronic device.

2. The method of claim 1 wherein the first wireless network is a cellular wireless wide area network (WAN) and the second wireless network is a wireless local area network (WLAN), the wireless WAN having a slower downlink speed to the mobile electronic device than the WLAN, wherein adapting the content when the selected wireless network is the wireless WAN includes removing information from the content to reduce the size thereof.

3. The method of claim 2 wherein adapting the content when the selected wireless network is the WLAN includes removing information from the content to reduce the size of thereof, the size of information removed when the selected wireless network is the WLAN being less than the size of information removed than if the selected wireless network is the wireless WAN.

4. The method of claim 2 including determining if the selected wireless network is the WLAN, and if so, sending the content without adapting the content to reduce the size thereof.

5. The method of claim 2 wherein the content includes information for generating a web page, the information Including reference files and a computer instruction file including instructions for generating the web page, the instructions including references to the references files, wherein adapting the content when the selected wireless network is the wireless WAN includes deleting at least some of the reference files from the content.

6. The method of claim 5 wherein the references files include video files, wherein adapting the content when the selected wireless network is the wireless WAN includes deleting the video files from the content.

7. The method of claim 5 wherein adapting the content when the selected wireless network is the wireless WAN includes deleting from the content the reference files that are predetermined file types and exceed a predetermined file size.

8. The method of claim 2 wherein the content includes information for generating a web page, the information including at least one image file for generating an associated image and a computer instruction file including instructions for generating the web page, the instructions referencing the image file, wherein adapting the content when the selected wireless network is the wireless WAN includes converting the image file to a lower resolution Image file.

9. The method of claim 2 wherein the content includes Information for generating a web page, the information including image files for generating associated images and a computer instruction file including instructions for generating the web page, the instructions referencing the image file, wherein adapting the content when the selected wireless network is the wireless WAN includes determining which of the image file exceed a predetermined size and converting the determined image files to a lower resolution image file.

10. The method of claim 2 wherein the content includes an email message, wherein adapting the content when the selected wireless network is the wireless WAN includes converting the email message to a plain text email message.

11. The method of claim 10 wherein when the selected wireless network is the WLAN, the email message is not converted to a plan text email message prior to sending to the mobile electronic device.

12. The method of claim 2 wherein the content includes an email message having an attachment, wherein adapting the content when the selected wireless network is the wireless WAN includes removing the attachment from the email message.

13. The method of claim 12 wherein the selected wireless network is the WLAN, the email message is sent with the attachment to the mobile electronic device.

14. The method of claim 2 wherein the wireless WAN includes a cellular network compatible with at least one of GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EDGE (Enhanced Data rates for GSM Evolution) and UMTS (Universal Mobile Telecommunications Systems); and the WLAN is compatible with IEEE 802.11.

15. A wireless connector system for interfacing between a content source and at least a first wireless network and a second wireless network, the wireless networks having respective coverage areas for providing service to a plurality of mobile electronic devices, the wireless connector system including:
data conversion means for (i) receiving from the content source content that is destined for a mobile electronic device through a selected one of the wireless networks and (ii) adapting the content based on the selected wireless network and outputting the adapted content,
the wireless connector system being configured for providing the content outputted by the data conversion means to the selected wireless network for sending to the mobile electronic device.

16. The system of claim 15 wherein the first wireless network is a cellular wireless wide area network (WAN) and the second wireless network is a wireless local area network (WLAN), the wireless WAN having a slower downlink speed to the mobile electronic device than the WLAN, wherein the data conversion means Is configured to adapt the content when the selected wireless network is the wireless WAN by removing information from the content to reduce the size thereof.

17. The system of claim 16 wherein the data conversion means is configured to adapt the content when the selected wireless network is the WLAN by removing information from the content to reduce the size of thereof, the size of information removed when the selected wireless network is the WLAN being less than the size of information removed than if the selected wireless network Is the wireless WAN.

18. The system of claim 16 wherein the content includes information for generating a web page, the information including reference files and a computer instruction file including instructions for generating the web page, the instructions including references to the references files, wherein the data conversion means is configured to adapt the content when the selected wireless network is the wireless WAN by deleting at least some of the reference files from the content.

19. The system of claim 18 wherein the data conversion means is configured to adapt the content when the selected wireless network is the wireless WAN by deleting from the content the reference files that are predetermined file types and exceed a predetermined file size.

20. The system of claim 16 wherein the content includes an email message, wherein the data conversion means is configured to adapt the content when the selected wireless network is the wireless WAN by converting the email message to a plain text email message.

21. The system of claim 16 wherein the content includes an email message, wherein the data conversion means is configured to adapt the content when the selected wireless network is the wireless WAN by removing the attachment from the email message.
